(19) United States
(12) Patent Application Publication
(10) Pub. No.: US 2018/0015443 A1
(43) Pub. Date: Jan. 18, 2018

(54) NICKEL-BASED CATALYST FOR THE DECOMPOSITION OF AMMONIA

(71) Applicant: GENCELL LTD., Petah Tikva (IL)

(72) Inventors: Gennadi FINKELSHTAIN, Modiin (IL); Nino BORCHTCHOUKOVA, Modiin (IL); Leonid TITELMAN, Petah Tikva (IL)

(21) Appl. No.: 15/548,214

(22) PCT Filed: Feb. 1, 2016
(86) PCT No.: PCT/US2016/015894

§ 371 Date: Aug. 2, 2017

Related U.S. Application Data
(60) Provisional application No. 62/111,171, filed on Feb. 3, 2015.

(51) Int. Cl. B01J 23/78; B01J 35/02; B01J 8/24; C01B 3/04; B01J 8/02

(52) U.S. Cl. CPC B01J 23/78; C01B 3/047; B01J 8/0242; B01J 8/24; B01J 35/023

(57) ABSTRACT

The invention relates to a catalyst for the thermal decomposition of ammonia. The catalyst comprises at least 25% by weight of nickel oxide and is present in powder form and/or comprises from 30% to 42% by weight of nickel oxide. Also disclosed is a process for the thermal decomposition of ammonia into hydrogen and nitrogen, which process comprises contacting ammonia with the catalyst of the invention.

### CROSS-REFERENCE TO RELATED APPLICATIONS

The present application claims priority of U.S. Provisional Patent Application No. 62/111,171, filed Feb. 3, 2015, the entire disclosure of which is expressly incorporated by reference herein.

### BACKGROUND OF THE INVENTION

### 1. Field of the Invention

The present invention relates to a nickel-based catalyst for the thermal decomposition of ammonia into hydrogen and nitrogen. This catalyst allows the efficient decomposition of ammonia at relatively low temperatures, e.g., temperatures of 600° C. and below.

### 2. Discussion of Background Information

One of the environmentally most benign ways of generating energy is the use of hydrogen as fuel, for example in a fuel cell. The only combustion product of a fuel cell, i.e., water apparently does not pose any risks to the environment. However, the main challenge of this technology is provide the hydrogen fuel in an efficient manner. There is a need to contain a useful quantity of hydrogen in a small volume. Such containment requires either refrigerating the hydrogen until it achieves the liquid state or compressing it to 5,000 psi. Both processes involve considerable expense. Further, the small hydrogen molecules can leak through holes and cracks too small for other molecules and they can diffuse into the crystalline structure of metals and thereby embrittle them. Accordingly, the main obstacle to using hydrogen fuel cells lies in the requirement to store enough hydrogen in an efficient way to make the cell practical.

One approach to overcome the drawbacks of using hydrogen as a fuel is to generate it from a compound that is easier to store and transport than hydrogen in a separate reactor which can be connected to the fuel cell. Ammonia is such a compound. As a fuel ammonia has several advantages over hydrogen and hydrocarbon fuels. For example, ammonia is a common industrial chemical and is used, for example, as the basis for many fertilizers. Producers also transport it and contain it in tanks under modest pressure, in a manner similar to the containment and transport of propane. Thus there already is a mature technology in place for producing, transporting and storing ammonia. Further, although ammonia has some toxicity when inhaled, ammonia inhalation can easily be avoided because it has a readily detected odor. Ammonia also does not readily catch fire, as it has an ignition temperature of 650° C. If no parts of an ammonia-based power system reach that temperature, then any ammonia spilled in an accident will simply dissipate.

Hydrogen can be generated from the ammonia in an endothermic reaction carried out in a device separate from the fuel cell. Ammonia decomposition reactors (ammonia crackers) catalytically decompose ammonia into hydrogen and nitrogen. However, this reaction requires high temperatures of 400-1000° Celsius.

U.S. Pat. Nos. 5,055,282 and 5,976,723, the entire disclosures of which are incorporated by reference herein, disclose a method for cracking ammonia into hydrogen and nitrogen in a decomposition reactor. The method consists of exposing ammonia to a suitable cracking catalyst under conditions effective to produce nitrogen and hydrogen. In this case the cracking catalyst consists of an alloy of zirconium, titanium, and aluminum doped with two elements from the group consisting of chromium, manganese, iron, cobalt, and nickel.

U.S. Pat. No. 6,936,363, the entire disclosure of which is incorporated by reference herein, discloses a method for the production of hydrogen from ammonia based on the catalytic dissociation of gaseous ammonia in a cracker at 500-750° C. A catalytic fixed bed is used; the catalyst is Ni, Ru and Pt on Al₂O₃. The ammonia cracker supplies a fuel cell (for example, an alkaline fuel cell AFC) with a mixture of hydrogen and nitrogen. Part of the supplied hydrogen is burned in the ammonia cracker for the supply of the energy needed for the ammonia dissociation process.

Despite advances in the art, there still is a need for an inexpensive (i.e., not requiring and preferably substantially free of expensive metals) catalyst that can decompose ammonia in an efficient way over a wide range of temperatures, including at a relatively low temperature.

### SUMMARY OF THE INVENTION

The present invention provides a first nickel-based catalyst for the thermal decomposition of ammonia (e.g., at relatively high temperatures such as 700° to 800° C.). The first catalyst comprises at least 25% by weight of nickel oxide and is present in powder/pulverulent form (i.e., not in the form of, e.g., pellets).

In embodiments of the first catalyst, at least 50%, e.g., at least 75% of all powder particles may have a particle size of not more than 0.5 mm. For example, at least 90% of all powder particles may have a particle size of not more than 0.25 mm and/or at least 95% of all powder particles may have a particle size of not more than 0.1 mm.

In other embodiments of the first catalyst, not more than 10% of all powder particles may have a particle size of more than 1 mm, e.g., more than 0.5 mm. For example, not more than 5% of all powder particles may have a particle size of more than 0.7 mm.

In yet further embodiments of the first catalyst, at least 90% by weight of all powder particles may have a particle size of not more than 0.5 mm. For example, at least 95% by weight of all powder particles may have a particle size of not more than 0.25 mm.

In still further embodiments of the first catalyst of the present invention, the catalyst may comprise at least 30% by weight, e.g., at least 34% by weight of nickel oxide and/or the catalyst may comprise not more than 42% by weight, e.g., not more than 38% by weight of nickel oxide.

The present invention also provides a second nickel-based catalyst for the thermal decomposition of ammonia. The second catalyst comprises from 30% to 42% by weight of nickel oxide (based on the total weight of the catalyst).

In embodiments of the second catalyst, the catalyst may comprise at least 34% by weight of nickel oxide and/or may comprise not more than 40% by weight of nickel oxide.

In further embodiments of the first and second catalysts of the present invention, the catalyst may further comprise inert material that comprises alumina and/or calcium aluminate. The inert material may further comprise other materials.

In yet further embodiments of the first and second catalysts, the catalyst may be present in partially or completely reduced form. For example, the catalyst may have been reduced by hydrogen (or a hydrogen-containing gas) and/or ammonia.

In a still further embodiments of the first and second catalysts according to the present invention, the catalyst may be capable of decomposing at least 99.8% by volume of ammonia, e.g., at least 99.85% by volume of ammonia at 575° C. and a gas hourly space velocity of hydrogen plus nitrogen of 2,000 h⁻¹.

The present invention also provides a reactor for the thermal decomposition of ammonia. The reactor comprises a catalyst according to the present invention as set forth above (including the various aspects thereof).

In an embodiment, the reactor of the present invention may be capable of decomposing at least 99.8% by volume of ammonia at 575° C. and a gas hourly space velocity of hydrogen plus nitrogen of 2,000 h⁻¹.

In other embodiments, the reactor may be connected to a hydrogen fuel cell in a way which allows hydrogen produced in the reactor to be used as fuel for the fuel cell.

The present invention also provides a process for the thermal decomposition of ammonia into hydrogen and nitrogen. The process comprises contacting ammonia with a catalyst according to the present invention as set forth above (including the various aspects thereof).

In embodiments of the process of the present invention, the process may carried out at a temperature of not higher than 600° C., e.g., not higher than 575° C.

In further embodiments of the process, at least at least 99.8% by volume, e.g., at least 99.85% by volume of ammonia may be decomposed.

The present invention also provides a process for generating hydrogen. The process comprises contacting ammonia with a catalyst according to the present invention as set forth above at a temperature of at least 500° C., e.g., at least 525° C., at least 550° C., or at least 575° C., but preferably not higher than 650° C., e.g., not higher than 625° C., or not higher than 600° C.

The present invention further provides a hydrogen fuel cell. The fuel cell uses as fuel hydrogen which comprises hydrogen that has been produced by a process of the present invention as set forth above (including the various aspects thereof).

### BRIEF DESCRIPTION OF THE DRAWINGS

The present invention is further described in the detailed description which follows, in reference to the accompanying drawings by way of non-limiting examples of exemplary embodiments of the present invention. In the drawings:

FIG. 1 schematically shows an apparatus used in the Examples below for thermally decomposing ammonia;

FIG. 2 schematically shows the catalyst-loaded reactor of the apparatus of FIG. 1; and

FIG. 3 and FIG. 4 graphically represent the residual ammonia concentration in a hydrogen/nitrogen gas mixture obtained after the thermal decomposition of ammonia as a function of decomposition temperature for several catalysts according to the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

As used herein, the singular forms “a,” “an,” and “the” include the plural reference unless the context clearly dictates otherwise. For example, reference to “a gas” would also mean that mixtures of two or more gases can be present unless specifically excluded.

Except where otherwise indicated, all numbers expressing quantities of ingredients, reaction conditions, etc. used in the instant specification and appended claims are to be understood as being modified in all instances by the term “about.” Accordingly, unless indicated to the contrary, the numerical parameters set forth in the present specification and the appended claims are approximations that may vary depending upon the desired properties sought to be obtained by the present invention. At the very least, each numerical parameter should be construed in light of the number of significant digits and ordinary rounding conventions.

Additionally, the disclosure of numerical ranges within this specification is considered to be a disclosure of all numerical values and ranges within that range. For example, if a range is from 1 to 50, it is deemed to include, for example, 1, 7, 34, 46.1, 23.7, or any other value or range within the range.

The present invention is based on the unexpected finding that both the percentage of nickel oxide in the catalyst (and thus the concentration of metallic nickel in the reduced form of the catalyst) and the particle size/particle size distribution of the catalyst significantly affects the performance of the catalyst. As set forth in more detail below, there is a non-linear relationship between the concentration of nickel oxide in the catalyst and the catalyst performance. Further, employing the catalyst in powder form instead of in granulated or pellet form significantly reduces the temperature at which an efficient decomposition of ammonia into hydrogen and nitrogen can be effected.

The catalyst of the present invention comprises at least 25% by weight of nickel oxide, e.g., at least 30%, at least 31%, at least 32%, at least 33%, or at least 34% by weight of nickel oxide (here and in the following based on the total weight of the catalyst). However, the catalyst of the present invention preferably does not comprise more than 42%, e.g., not more than 41%, not more than 40%, not more than 39%, or not more than 38% by weight of nickel oxide. Particularly good results are usually obtained when the concentration of nickel oxide in the catalyst ranges from 34% to 38% by weight of nickel oxide.

Further, the catalyst of the present invention is preferably present in powder or pulverulent form. In a first embodiment of the powdered catalyst, at least 50%, e.g., at least 60%, at least 70%, at least 75%, or substantially all (at least 99%) of all powder particles have a particle size of not more than 0.5 mm, e.g., not more than 0.4 mm, not more than 0.3 mm, not more than 0.2 mm, or not more than 0.1 mm. The powder particles may have various regular and irregular shapes. Here and in the following the size of a powder particle is to be understood to be its largest dimension.

Nickel-based catalysts are commercially available, but usually only in bead or pellet form and the like, having a largest dimension (e.g. diameter) of usually at least about 5 mm. If such a commercially available catalyst is to be used, the first catalyst of the present invention can be produced from the commercial product by comminuting (e.g. grinding) it to the desired particle size.

In a second embodiment of the powdered catalyst, which may include the first embodiment, at least 90%, e.g., at least 91%, at least 92%, at least 93%, at least 94%, at least 95%, at least 96%, at least 97%, or substantially all powder particles have a particle size of not more than 0.5 mm, e.g., not more than 0.4 mm, not more than 0.3 mm, or not more than 0.25 mm.

In a third embodiment of the powdered catalyst, which may include the first and second embodiments set forth above, not more than 10%, e.g., not more than 7%, or not more than 5% of all powder particles have a particle size of more than 1 mm, e.g., more than 0.7 mm, or more than 0.6 mm. For example, not more than 5% of all powder particles may have a particle size of more than 0.5 mm.

En a fourth embodiment of the powdered catalyst, which may include the first to third embodiments set forth above, at least 90% by weight, e.g., at least 95% by weight of all powder particles have a particle size of not more than 1 mm, e.g., not more than 0.9 mm, not more than 0.8 mm, or not more than 0.7 mm. For example, at least 95% by weight, e.g., at least 96%, at least 97%, at least 98% or at least 99% by weight of all powder particles may have a particle size of not more than 0.7 mm.

In addition to nickel oxide, the catalyst of the present invention will usually comprise one or more inert materials. Non-limiting examples of suitable inert materials include one or more of alumina, calcium aluminate, graphite, silica, titania, zirconia, calcium oxide, magnesium oxide, and any other oxides of main group metals and transition metals. The catalyst may also comprise one or more additional materials which can catalyze the thermal decomposition of ammonia, but it will usually be substantially free of corresponding materials. In particular, the catalyst will usually contain not more than trace amounts, if any, of noble metals and other expensive (transition) metals such as Rh, Ir, Pd, Pt, etc. If other transition metals are present at all, their total concentration will usually be lower than the concentration of nickel by a factor of at least 2, e.g., by a factor of at least 3, at least 5, or at least 10.

One of ordinary skill in the art will be aware that in order to be able to effectively catalyze the thermal decomposition of ammonia the catalyst of the present invention has to be reduced at least partially. Ammonia and/or hydrogen gas may, for example, be used for this purpose. If the catalyst is initially used in only partially reduced form it will be reduced completely by the ammonia with which it is contacted at elevated temperature and also by the hydrogen gas that is generated due to the decomposition of ammonia.

In a preferred embodiment, the reactor for the thermal decomposition of ammonia (ammonia cracker) provided by the present invention is capable of decomposing at least 99.8% by volume, e.g., at least 99.85% by volume, or at least 99.87% by volume of ammonia at 575° C. and a gas hourly space velocity of hydrogen plus nitrogen of 2,000 h⁻¹. In other words, in this case the hydrogen/nitrogen mixture leaving the ammonia cracker will contain not more than 0.2% by volume, e.g., not more than 0.15%, or not more than 0.13% by volume of ammonia. The catalyst may be provided in the reactor in the form of, for example, a fixed bed or a fluid bed.

The reactor is thus capable of providing a mixture of hydrogen and nitrogen (in a molar ratio of 3:1), which mixture contains only very small amounts of ammonia (e.g., not more than 0.2% by volume) and is thus suitable for providing hydrogen to any apparatus that uses hydrogen (diluted with nitrogen) as fuel, such as a hydrogen-based fuel cell (e.g., an alkaline fuel cell). A corresponding fuel cell may, for example, be used as replacement for a conventional source of electrical energy such as a fuel-based generator or may provide energy for a car. In other words, the present invention also provides a process for the generation of electricity that comprises using a hydrogen-based fuel cell such as an alkaline fuel cell that is connected to a reactor which contains a Ni-based catalyst of the present invention as set forth above.

The process for the thermal decomposition of ammonia into hydrogen and nitrogen according to the present invention comprises contacting gaseous ammonia with a catalyst (or feeding ammonia into a reactor) according to the present invention (usually at atmospheric pressure, although lower and higher pressures may also be employed). This process can advantageously be carried out at relatively low temperature, even if the degree of ammonia decomposition needs to be high (e.g., at least 99.8% by volume of ammonia decomposed). Suitable temperatures are as low as 575° C., although higher temperatures such as at least 580° C., at least 585° C., at least 590° C., or at least 590° C. may, of course, be employed and may result in an even higher degree of ammonia decomposition. Usually, temperatures not exceeding 650° C., e.g. not exceeding 625° C. and in particular, not exceeding 600° C. will be sufficient for providing a mixture of hydrogen and nitrogen that can be employed without any further purification in a hydrogen-based fuel cell.

### Examples

### 1. Effect of Nickel Concentration in Ni-Based Catalyst

In order to study the effect of the concentration of nickel in the catalyst on the decomposition of ammonia into hydrogen and nitrogen tests were performed with catalyst pellets containing NiO as well as CaO and Al₂O₃ (weight ratio about 1:7, comprising alumina and calcium aluminate) as inert materials. The pellets had a diameter of about 6 mm and a height of about 4 mm, with a bulk density of about 1.1 kg/L.

Pellets containing NiO in concentrations, in % by weight, of 25, 28.5, 34.9, 37.5 and 49.7 were tested under identical conditions (following reduction with ammonia) in a reactor at gas hourly space velocities (GHSV) of 1,000, 1,500, 2,750 and 5,000 h⁻¹ and the residual concentration (in % by volume) of undecomposed ammonia in the gas mixture leaving the ammonia cracker was determined in each instance. The results obtained were as follows:

TABLE 1
Relationship between residual ammonia concentration and
concentration of NiO in catalyst at GHSV of 1,000 hr⁻¹

| | Residual ammonia after cracking, % by volume | | | | |
|---|---|---|---|---|---|
| Temperature | | | | 37.5% | 49.7% |
| ° C. | 25% NiO | 28.5% NiO | 34.9% NiO | NiO | NiO |
| 500 | 3.2500 | 2.9300 | 2.4500 | 2.4000 | 4.5000 |
| 525 | 0.6000 | 0.5500 | 0.3800 | 0.3500 | 0.7500 |
| 550 | 0.1470 | 0.1240 | 0.1150 | 0.1030 | 0.1940 |
| 575 | 0.0900 | 0.0850 | 0.0770 | 0.0740 | 0.0840 |
| 600 | 0.0700 | 0.0660 | 0.0645 | 0.0620 | 0.0700 |
| 625 | 0.0650 | 0.0620 | 0.0570 | 0.0550 | 0.0590 |
| 650 | 0.0550 | 0.0520 | 0.0500 | 0.0500 | 0.0540 |
| 675 | 0.0540 | 0.0490 | 0.04850 | 0.0480 | 0.0520 |
| 700 | 0.0520 | 0.0480 | 0.0475 | 0.0470 | 0.0510 |

TABLE 2
Relationship between residual ammonia concentration and
concentration of NiO in catalyst at GHSV of 1,500 hr⁻¹

| | Residual ammonia after cracking, % by volume | | | | |
|---|---|---|---|---|---|
| Temperature | | | | 37.5% | 49.7% |
| ° C. | 25% NiO | 28.5% NiO | 34.9% NiO | NiO | NiO |
| 500 | 3.2500 | 2.9300 | 2.4500 | 2.4000 | 4.5000 |
| 525 | 0.6000 | 0.5500 | 0.3800 | 0.3500 | 0.7500 |
| 550 | 0.1470 | 0.1240 | 0.1150 | 0.1030 | 0.1940 |
| 575 | 0.0900 | 0.0850 | 0.0770 | 0.0740 | 0.0840 |
| 600 | 0.0700 | 0.0660 | 0.0645 | 0.0620 | 0.0700 |
| 625 | 0.0650 | 0.0620 | 0.0570 | 0.0550 | 0.0590 |
| 650 | 0.0550 | 0.0520 | 0.0500 | 0.0500 | 0.0540 |
| 675 | 0.0540 | 0.0490 | 0.04850 | 0.0480 | 0.0520 |
| 700 | 0.0520 | 0.0480 | 0.0475 | 0.0470 | 0.0510 |

TABLE 3
Relationship between residual ammonia concentration and
concentration of NiO in catalyst at GHSV of 2,750 hr⁻¹

| | Residual ammonia after cracking, % by volume | | | | |
|---|---|---|---|---|---|
| Temperature | | | | 37.5% | 49.7% |
| ° C. | 25% NiO | 28.5% NiO | 34.9% NiO | NiO | NiO |
| 500 | 9.5000 | 8.2500 | 7.3500 | 7.2500 | 9.6000 |
| 525 | 3.2500 | 2.9300 | 2.5700 | 2.5000 | 3.8000 |
| 550 | 0.5500 | 0.3500 | 0.2750 | 0.2250 | 0.5000 |
| 575 | 0.1640 | 0.1450 | 0.1300 | 0.0820 | 0.1540 |
| 600 | 0.0690 | 0.0700 | 0.0640 | 0.0570 | 0.0700 |
| 625 | 0.0580 | 0.0560 | 0.0480 | 0.0480 | 0.0540 |
| 650 | 0.0500 | 0.0480 | 0.0440 | 0.0430 | 0.0490 |
| 675 | 0.0480 | 0.0455 | 0.0410 | 0.0400 | 0.0440 |
| 700 | 0.0470 | 0.0440 | 0.0390 | 0.0380 | 0.0425 |

TABLE 4
Relationship between residual ammonia concentration and
concentration of NiO in catalyst at GHSV of 5,000 hr⁻¹

| | Residual ammonia after cracking, % by volume | | | | |
|---|---|---|---|---|---|
| Temperature | | | | 37.5% | 49.7% |
| ° C. | 25% NiO | 28.5% NiO | 34.9% NiO | NiO | NiO |
| 500 | 17.0000 | 14.6000 | 12.7000 | 12.5000 | 15.8000 |
| 525 | 9.7500 | 9.0000 | 8.5000 | 8.6000 | 10.6500 |
| 550 | 5.0000 | 4.1000 | 3.6000 | 3.5000 | 5.4000 |
| 575 | 1.2500 | 1.2000 | 0.7500 | 0.7000 | 1.2500 |
| 600 | 0.2500 | 0.2100 | 0.1730 | 0.1600 | 0.2800 |
| 625 | 0.0760 | 0.0750 | 0.0525 | 0.0450 | 0.0830 |
| 650 | 0.0450 | 0.0440 | 0.0350 | 0.0320 | 0.0480 |
| 675 | 0.0370 | 0.0360 | 0.0320 | 0.0290 | 0.0420 |
| 700 | 0.0340 | 0.0310 | 0.0300 | 0.0280 | 0.0400 |

The following conclusions can be drawn from the above results:
(1) Independent of the GHSV, the activity of the catalyst increases with increasing NiO concentration from 25 wt % to 37.5 wt %, but thereafter decreases with increasing NiO concentration.
(2) The maximum catalyst activity is shown by samples containing 34.9-37.5 wt % of NiO.
(3) The biggest difference in catalytic activity is in the temperature range of 500-550° C.
(4) At cracking temperatures of 650° C. and higher the catalyst activity is almost independent of the NiO concentration in the catalyst.

### 2. Effect of Particle Size of Catalyst on Catalytic Activity

In order to determine the effect of the particle size on the activity of the catalyst some of the pellets used for the determination of the catalytic activity as a function of the NiO concentration (25%, 34%, 37.8% NiO) were subjected to grinding in a grinding machine and then sieved. Thereafter the catalytic activity of the catalysts was determined.

The powdered catalysts were first dried at 350° C. for about 1 hour in a nitrogen atmosphere and then reduced with ammonia in a laboratory oven at 450° C. and then at 600° C. for 5 hours. Testing of the catalytic activity was performed in the same oven with a flow of ammonia of 0.086 L/min during the next 3 hours at a temperature in the range of 510-620° C. The inlet gas pressure was measured. The temperature of the hydrogen/nitrogen mixture leaving the reactor was measured.

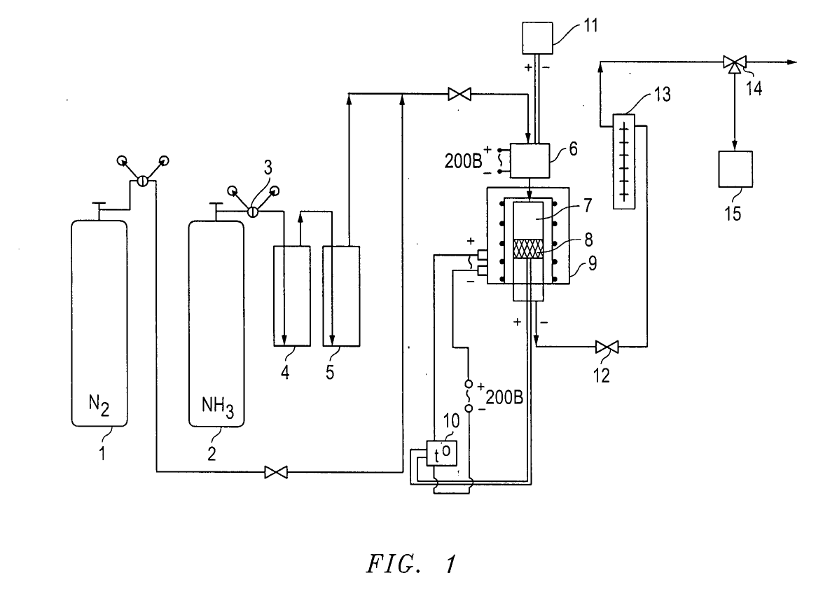

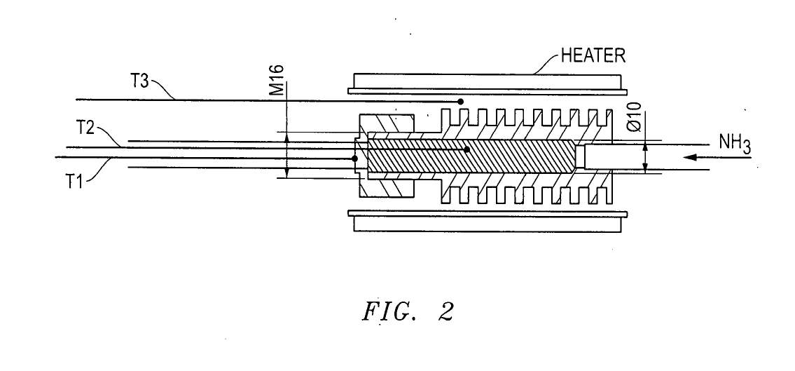

The apparatus used for testing is shown in FIG. 1 and the design of the reactor used in the system is shown in FIG. 2.

The apparatus shown in FIG. 1 is designed for studying catalyst activity in the decomposition of ammonia at flow rates of ammonia of up to 90,000 h−1, pressures up to 10 atm and with the possibility of varying operating temperatures up to a temperature of 1000° C. The apparatus comprises two infrared gas analyzers. The ammonia 2 passes reducer 3, where its pressure is reduced to the desired value, after which it is freed from moisture and oil impurities in columns 4 and 5. The dried and purified gas flows to the ammonia heater 6 where it is preheated to a temperature of 450° C. and above before entering the reactor 7 (volume 5 cm³) which is loaded with the catalyst 8 (5 g, with the powder held on gas-permeable ceramic wool stoppers). The temperature of the gas preheater is recorded by the potentiometer 11. For reaching the desired temperature the reactor is placed in an electric furnace 9. The heating of the furnace is regulated for desired temperature of the catalyst bed by a microprocessor controller 10. The gas heater is measured by thermocouples HA.

The catalytic decomposition of ammonia takes place on the catalyst 8. The nitrogen-hydrogen mixture obtained from the cracking of ammonia passed through the fine adjustment valve 12 is directed to the rheometer 13 for measuring the flow of gas exiting from the reactor. Changing the flow rate of ammonia is carried out by the valve 12. The rheometer has a three-way valve 14 through which gas is directed to the detector 15 which records the residual ammonia concentration or is released into the atmosphere.

The following results were obtained with a GHSV of nitrogen and hydrogen leaving the reactor of 2,000 h⁻¹ (absolute ammonia pressure at reactor inlet 1.8-2.3 bar).

TABLE 5
Relationship between residual ammonia concentration
(% by volume) in hydrogen/-nitrogen mixture and particle
size of catalyst (25 wt % NiO) at a GHSV of 2,000 hr⁻¹

| | Catalyst particle size, mm | | | |
|---|---|---|---|---|
| Temperature, ° C. | 0.315-0.63 | 0.63-1.00 | 1.00-1.60 | 2.00-3.00 |
| 470 | 5.9500 | 9.5000 | 9.9000 | 10.2500 |
| 480 | 3.2000 | 6.4000 | 6.7500 | 7.1000 |
| 490 | 1.6000 | 3.6500 | 4.0000 | 4.2000 |
| 500 | 0.7500 | 1.7000 | 1.9500 | 2.1000 |
| 510 | 0.3250 | 0.7500 | 0.9000 | 1.2000 |
| 520 | 0.1750 | 0.4000 | 0.5000 | 0.7500 |
| 530 | 0.1375 | 0.2250 | 0.2500 | 0.5500 |
| 540 | 0.1150 | 0.1570 | 0.1620 | 0.4500 |
| 550 | 0.1025 | 0.1280 | 0.1380 | 0.4000 |
| 560 | 0.0975 | 0.1150 | 0.1325 | 0.3000 |
| 570 | 0.0960 | 0.1200 | 0.1290 | 0.2300 |
| 575 | 0.0950 | 0.1100 | 0.1275 | 0.2000 |

As can be taken from the results set forth in Table 5, the concentration of residual ammonia decreases with decreasing particle size and increasing temperature. For example, at a cracking temperature of 575° C. the concentration of residual ammonia in the gas mixture leaving the reactor (cracker) is 0.0950% by volume when the catalyst particle size is in the range from 0.315 to 0.63 mm, whereas with a catalyst particle size in the range from 2.00 to 3.00 mm the concentration of residual ammonia in the gas mixture leaving the reactor is more than twice as high, 0.200% by volume.

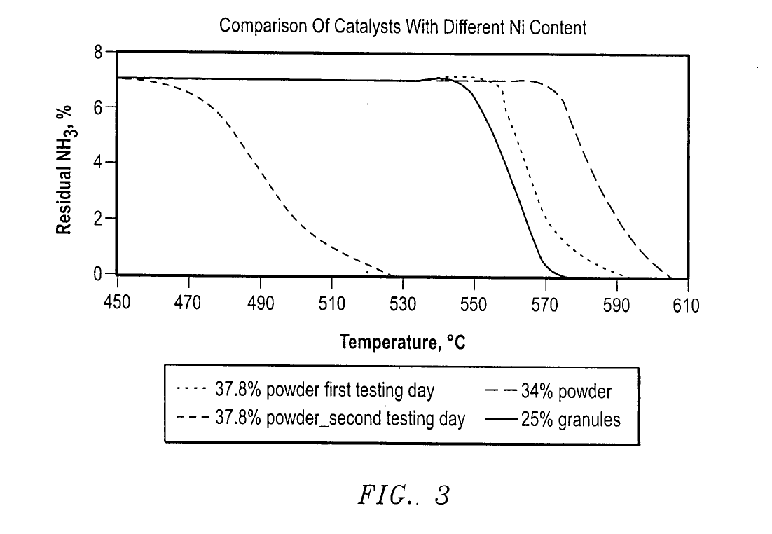

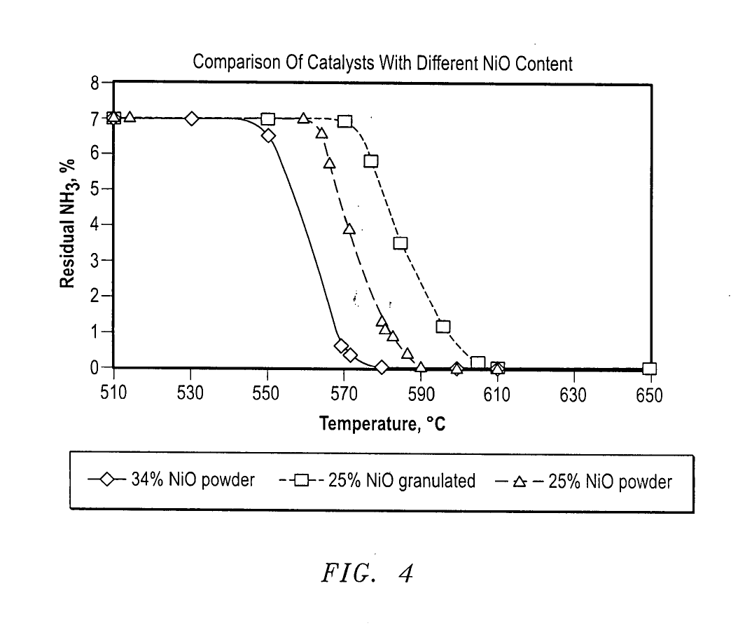

That powdered catalyst is superior to catalyst in pellet form in terms of catalyst activity is also demonstrated by the results graphically illustrated in FIG. 3 and FIG. 4. The results for powdered catalyst and catalyst pellets were obtained under similar conditions. As can be seen, at all temperatures tested, at the same catalyst concentration the powdered catalyst affords a much lower concentration of residual ammonia in the gas leaving the cracker than the catalyst in pellet form.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1.-15. (canceled)

16. A catalyst for the thermal decomposition of ammonia, wherein the catalyst (i) comprises at least 25% by weight of nickel oxide and is present in powder form and/or (ii) comprises from 30% to 42% by weight of nickel oxide.

17. The catalyst of claim 16, wherein the catalyst is present in powder form.

18. The catalyst of claim 17, wherein at least 50% of all powder particles have a particle size of not more than 0.5 mm.

19. The catalyst of claim 17, wherein at least 90% of all powder particles have a particle size of not more than 0.25 mm.

20. The catalyst of claim 17, wherein at least 95% of all powder particles have a particle size of not more than 0.1 mm.

21. The catalyst of claim 17, wherein not more than 10% of all powder particles have a particle size of more than 1 mm.

22. The catalyst of claim 17, wherein not more than 5% of all powder particles have a particle size of more than 0.7 mm.

23. The catalyst of claim 17, wherein the catalyst comprises at least 30% by weight of nickel oxide.

24. The catalyst of claim 23, wherein the catalyst comprises at least 34% by weight of nickel oxide.

25. The catalyst of claim 17, wherein the catalyst comprises not more than 42% by weight of nickel oxide.

26. The catalyst of claim 25, wherein the catalyst comprises not more than 38% by weight of nickel oxide.

27. The catalyst of claim 17, wherein the catalyst further comprises inert material comprising at least one of alumina and calcium aluminate.

28. The catalyst of claim 16, wherein the catalyst is present in partially or completely reduced form.

29. The catalyst of claim 28, wherein the catalyst has been reduced by at least one of hydrogen and ammonia.

30. The catalyst of claim 16, wherein the catalyst comprises from 30% to 42% by weight of nickel oxide.

31. The catalyst of claim 30, wherein the catalyst further comprises inert material comprising at least one of alumina and calcium aluminate.

32. A reactor for the thermal decomposition of ammonia, wherein the reactor comprises the catalyst of claim 16.

33. The reactor of claim 32, wherein the reactor is capable of decomposing at least 99.8% by volume of ammonia at 575° C. and a gas hourly space velocity of hydrogen plus nitrogen of 2,000 h⁻¹.

34. A process for the thermal decomposition of ammonia into hydrogen and nitrogen, wherein the process comprises contacting ammonia with the catalyst of claim 16.

35. The process of claim 34, wherein the process is carried out at a temperature of not higher than 600° C. and/or wherein at least 99.8% by volume of ammonia are decomposed.
